(19) United States
(12) Patent Application Publication
(10) Pub. No.: US 2013/0203025 A1
(43) Pub. Date: Aug. 8, 2013

(54) PERFORMANCE AND LEARNING ANALYSIS TOOL

(71) Applicants: Cheryl A. Cantrell, Belleville, IL (US); Nancy J. Burns, Fort Myers, FL (US); Jennifer R. Gates, Yorktown, VA (US)

(72) Inventors: Cheryl A. Cantrell, Belleville, IL (US); Nancy J. Burns, Fort Myers, FL (US); Jennifer R. Gates, Yorktown, VA (US)

(73) Assignee: Bank of America, Charlotte, NC (US)

(21) Appl. No.: 13/365,052

(22) Filed: Feb. 2, 2012

(51) Int. Cl. G09B 19/00

(52) U.S. Cl. 434/219

(57) ABSTRACT

Apparatus for calculating a value relating to the desirability of using a teaching method to train a group of employees. The apparatus may include a receiver configured to receive information relating to a first response selected from a first group of predetermined responses. The first group of predetermined responses may relate to responses to a first question. The apparatus may also include a processor configured to determine, based on the received first response, if the teaching method is a desirable teaching method. In the event that the teaching method is determined to be a desirable teaching method, the processor may assign a first value to the teaching method. In the event that the teaching method is determined to be an undesirable teaching method, the processor may assign a null value to the teaching method.

### FIELD OF TECHNOLOGY

This invention relates to a decision making tool. More specifically, this invention relates to using a decision making tool to assist in the formulation and execution of business-related decisions.

### BACKGROUND OF THE DISCLOSURE

Many businesses periodically train groups of employees. These businesses train employees with the purpose of familiarizing them with new skills, business protocols and/or government regulations.

Multiple learning solutions are available to train business employees. For example, instructor-led training, instructional websites, video presentations, web based training, simulations and case studies may be used. Each of these learning solutions may be created and implemented by the business and/or a third party.

When a business makes an internal decision to train a group of employees, it must determine an appropriate learning solution to be used for the employee training. Typically, each business associate assisting in the determination analyzes and prioritizes relevant information differently. This is undesirable at least because different approaches to selecting a learning solution may result in inconsistency in business policy and decisioning.

It would be desirable, therefore, to provide an automated system that assists business associates in making informed decisions using a consistent and systematic process.

### SUMMARY OF THE DISCLOSURE

A method for calculating values relating to the desirability of each of a plurality of teaching methods to train a group of employees. The method may include using a receiver to receive information relating to a first response selected from a first group of predetermined responses. The first group of predetermined responses may relate to responses to a first question. The method may also include using a processor to determine, based on the received first response, if each of the plurality of teaching methods is a desirable teaching method. In the event that a first subset of the plurality of teaching methods is determined to be desirable teaching methods, the processor may assign a first value to each of the teaching methods included in the first subset. In the event that a second subset of the plurality of teaching methods is determined to be undesirable teaching methods, the processor may assign a null value to each of the teaching methods included in the second subset.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a graphical user interface that may be used in accordance with the systems and methods of the invention;

FIG. 3 shows another graphical user interface that may be used in accordance with the systems and methods of the invention;

FIGS. 4A-4B shows yet another graphical user interface that may be used in accordance with the systems and methods of the invention;

FIG. 5 shows yet another graphical user interface that may be used in accordance with the systems and methods of the invention;

FIG. 6 shows yet another graphical user interface that may be used in accordance with the systems and methods of the invention;

FIGS. 7A-7D shows illustrative questions and answers that may be used in accordance with the systems and methods of the invention;

FIGS. 8A-8B shows yet another graphical user interface that may be used in accordance with the systems and methods of the invention;

FIG. 9 shows yet another graphical user interface that may be used in accordance with the systems and methods of the invention;

FIG. 10 shows an exemplary chart according to the systems and methods of the invention;

FIG. 11 shows yet another graphical user interface that may be used in accordance with the systems and methods of the invention;

FIG. 12 shows yet another graphical user interface that may be used in accordance with the systems and methods of the invention;

FIGS. 13A-13B shows exemplary graphs that may be used in accordance with the systems and methods of the invention;

FIG. 14 shows yet another graphical user interface that may be used in accordance with the systems and methods of the invention;

FIG. 15 shows yet another graphical user interface that may be used in accordance with the systems and methods of the invention;

FIG. 16 shows yet another graphical user interface that may be used in accordance with the systems and methods of the invention;

FIG. 17 shows yet another graphical user interface that may be used in accordance with the systems and methods of the invention; and

FIG. 18 shows an exemplary graph that may be used in accordance with the systems and methods of the invention.

### DETAILED DESCRIPTION OF THE DISCLOSURE

The systems and methods of the invention relate to assisting a business in selecting a learning solution. The learning solution may be a teaching method, teaching technique, system and/or process appropriate for educating a group of employees. The learning solution may familiarize the employees with one or more new skills, business protocols and/or government regulations. Exemplary learning solutions may include instructor led training, instructional websites, video presentations, web-based training, simulations and/or case studies.

The invention may include a Performance and Learning Analysis Tool (referred to alternately hereinafter as a “PLAT”). The invention may additionally include a Learning Solution Decisioning Matrix (referred to alternately hereinafter as a “LSDM”). The PLAT may be configured to receive information from one or more business associates. The LSDM may be configured to receive information input into the PLAT and, based on the received information, identify learning solutions appropriate for educating a group of business employees in one or more defined subject matters.

The PLAT and the LSDM may include one or more Excel™ spreadsheets, Word™ documents, and/or any other suitable electronic documents. In some embodiments, the PLAT and the LSDM may be downloaded onto a personal computer using a CD, USB, or a download button included on a Web Page. Alternatively, the PLAT and the LSDM may be accessed online via one or more Web Pages. Internet access to the PLAT and the LSDM may be password-encoded.

A PLAT Overview and Instructions Homepage (referred to alternately hereinafter as a “Homepage”) may initiate the display of the PLAT and the LSDM. The Homepage may include instructions relating to the usage of the PLAT and the LSDM. In some embodiments, the PLAT may include two separate groups of tabs. The Homepage may include selectable buttons that, when selected, either display or hide one or more of the tabs included in each of the groups of tabs.

The first group of tabs included in the PLAT may be Business Impact (referred to hereinafter as “BI”) Tabs. The BI Tabs may be used by a suitable business employee when collaborating with a third party. The collaboration may be for the purpose of determining whether to contract the third party to provide the business with one or more learning solutions.

An exemplary business employee that may use the BI tabs may be a Learning Consultant and/or a Learning Manager (referred to alternately hereinafter as an “LC”). An exemplary third party that may collaborate with the business may include any consulting firm that analyzes and designs education programs. Exemplary third parties that may collaborate with the business include Design Consultants (“DC”), Business Partners, Learning Consultants, Metrics Partners and Project Managers.

One or more of the BI Tabs may include one or more input fields. Exemplary input fields included in the BI Tabs are the rows and/or columns of one or more charts. The charts may include headers for the rows and/or columns to notify the user of the appropriate information to be input into the chart. Additional exemplary input fields are input fields substantially adjacent to displayed questions. These input fields may be configured to receive answers to the substantially adjacent questions.

The input fields may be configured to receive input from one or more business associates. For the purposes of this application, the input fields in the BI Tabs will be described as being completed by the LC, but it should be noted that any business associate(s) may fill the input fields.

The business may require some of the input fields included in the BI Tabs to be completed by the LC. The BI Tabs may identify the required input fields by shading them in a first color. The PLAT may use information input into the required fields to create a BI Agreement. For example, the PLAT may use information input into the required fields in the BI Tabs to populate fields in the BI Agreement.

The BI Agreement may be an agreement presented to a third party to review and sign prior to designing and developing a learning solution. The BI Agreement may be included in a BI tab entitled “BI Agreement.” Table 1 displays exemplary required input fields included in exemplary BI Tabs that may be used to populate fields in the BI Agreement:

TABLE 1

| BI Tab | Fields in the BI Tabs That are Fed into the BI Agreement |
|---|---|
| BusinessImpact - Business | Project Name |
| Need | Tracking Information |
| | Business Problem/Business Opportunity |
| | Key Business or Job Results |
| | Performance Goals/Objectives |
| | Additional information (In Scope/Out of Scope) |
| | What Existing Course Materials Can Be Used/Leveraged for this |
| | Learning Need? |
| BusinessImpact - Audience | Job Role |
| | Location(s) |
| | Special Considerations |
| | Audience Size |
| | Environment Restrictions/Technical Limitations |
| BusinessImpact - Business | Color-Coded Representation of a Business Readiness Roadmap |
| Readiness | (as completed by the LC) |
| | Project Readiness Recommendation (as completed by the LC) |
| BusinessImpact - Risks | Risk/Dependencies Description |
| | Consequences |
| | Mitigation Plan |
| | Risk Type |
| BusinessImpact - Budget | Are Funds Available? |
| | Line of Business (“LOB”) Funding Source |
| | Name of Finance Partner |
| | Cost Center |
| | High Level Estimate of Cost |
| | Link to Estimation Wizard |
| BusinessImpact - SME | Subject Matter Experts (SMEs) and Final Approver |
| Approve Contact | [includes: SMEs, Lead SME, Area of Expertise, Contact |
| | Information, Authorized By, and Contacted and Advised on |
| | Participation] |
| | Final Approver |
| | [includes: Approvers, Final Approver, Title, Contact |
| | Information, Authorized By, Contacted and Advised on |
| | Participation] |
| | Contacts |
| | [includes name and e-mail of: LOB Project Sponsor, Policy and |
| | Procedure Contacts, Learning Manager, Learning Consultant |
| | and Measurement Consultant, Other, Legal Reviewer and |
| | Compliance Reviewer] |
| | Key LOB Stakeholders |
| | [includes: name and e-mail of designated Key LOB |
| | Stakeholders] |
| BusinessImpact - Dates | Date the Solution is Required for Full Implementation |
| | Training Start Date |
| | Date Required for Pilot Implementation (If Appropriate) |
| | What is Driving These Dates? |

The BI Agreement may also include a BI Agreement Sign Off Field. The Field may include designated areas for the third party to sign and date. The Field may also state that approval of the BI Agreement implies an agreement on the size, scope and risks involved in the work on the date of approval. The BI Agreement may additionally state that modifications of any of the elements of the BI Agreement after approval constitute a change in the project scope that will require an order outlining impacts to timing, resources, or cost of the work.

It should be noted that the electronic display included in the BI Agreement Tab may be substantially similar to that of a formal document. The electronic display may additionally be a non-selectable display with no options to modify information. In some embodiments, the Homepage may include a button that, when selected, hides the BI tabs and displays only the BI Agreement.

The BI Agreement may be presented to the third party during contract negotiations. The BI Agreement may assist in avoiding misunderstandings between the business and the third party at least because it clarifies what the third party is expected to deliver to the business. In the event that the third party signs the BI Agreement, the terms and conditions of the BI Agreement may bind the third party and outline his duties of performance when providing the business with the selected learning solution.

It should be noted that one or more of the BI Tabs may display one or more questions. The displayed questions may help guide conversations between the LC and the third party. Questions that the business requires the LC to ask the third party may be shaded in the first color or a color different from the first color. Questions that the LC may optionally ask the third party may be shaded in a second color. The optional questions may be used to help answer the required questions. Both the required questions and the optional questions may be displayed substantially adjacent to an input field configured to receive information relating to the third party's response to the question(s).

The BI tabs may additionally include a Define Performance Gap Tab. The Define Performance Gap Tab may include additional questions helpful when determining business need and conducting project scope and analysis determinations. Each of the questions located adjacent to an input field may be configured to receive information relating to the answers of the questions.

The BI tabs may further include a Content Collection Plan Tab. The Content Collection Plan Tab may be configured to capture a plan for the collection of information needed to design and develop the learning solution. The LC and/or other business associates may complete this information. The Homepage may include a button that, when selected, displays only the Content Collection Plan Tab.

In some embodiments, the Content Collection Plan Tab may include multiple columns. Exemplary headings included in the Content Collection Plan Tab include: Content Type, Role(s), Person Responsible for Sending this Content, Date Content will be Sent, Date Content was Received, Location of the Content, Links to Content, Date Changes will Occur, Date Content Item Approved and/or SME Approver of Content.

The second group of tabs included in the PLAT may be Analysis Tabs. The Analysis Tabs may be used by one or more business associates during the analysis of the BI Agreement. For the purposes of this application, the input fields in the Analysis Tabs will be described as being completed by an Instructional Designer (referred to alternately hereinafter as an “ID”), but it should be noted that any business associate(s) may fill in the input fields.

One or more of the Analysis Tabs may include one or more input fields. Exemplary input fields included in the Analysis tabs are the rows and/or columns of one or more charts. The charts may include headers for the rows and/or columns to notify the user of the appropriate information to be input into the chart. Additional exemplary input fields are input fields substantially adjacent to displayed questions. These input fields may be configured to receive answers to the substantially adjacent questions.

It should be noted that at least some of the input fields included in the Analysis Tabs may be substantially identical to input fields included in the BI Tabs. In these embodiments, the PLAT may automatically populate one or more of the substantially identical input fields with the information input into the corresponding input fields in the BI Tabs.

The ID may change information in the Analysis Tabs that was input from the BI Tabs. However, in some embodiments, the business may request the ID not to change information input from the BI Agreement that was approved by the business and/or the third party. In these embodiments, the PLAT may display information originally approved by the business and/or the third party in a non-modifiable format. It should be noted that information in the event that information included in the Analysis Tabs, that originated from a BI tab, is modified, the information in the BI Tab may remain the same.

The business may require some of the input files included in the Analysis Tabs to be completed by the ID. The Analysis Tabs may identify the required input fields by shading them in a first color. The PLAT may use information input into the required fields to create an Analysis Agreement. For example, the PLAT may use information input into the required fields in the Analysis Tabs to populate fields in the Analysis Agreement.

The Analysis Agreement may be an agreement presented to the third party to review and sign prior to contracting with the business to design and develop a learning solution. The Analysis Agreement may be included in an Analysis Tab entitled “Analysis Agreement.” Table 2 displays exemplary required input fields included in exemplary BI and Analysis Tabs that may be used to populate fields in the Analysis Agreement:

TABLE 2

| BI and | Fields in the Analysis Tabs That are Fed into the Analysis |
|---|---|
| Analysis Tabs | Agreement |
| Analysis - Business Need | Project Name, Tracking Information |
| | Business Problem/Business Opportunity, Key Business or Job |
| | Results, Performance Goals/Objectives, Performance Gaps, |
| | Required Items to be Learned (Terminal Learning Objectives) |
| | Learning Solution Instructional Approach |
| | Recommended Learning Component(s), Required Items to be |
| | learned (Terminal Learning Objectives), Job Roles, Performance |
| | Level, Build Complexity Level, Instructional Approach - High |
| | Level, Assessment Strategy, Build Type, Estimated Length, |
| | LPPM #, Resources Required |
| | What Existing Course Materials can be Used or Leveraged for |
| | this Learning Need? |
| Analysis - Audience | Job Role |
| | Location(s) |
| | Special Considerations |
| | Audience Size |
| | Environment Restrictions/Technical Limitations |
| | Characteristics of the associates in these roles that could affect |
| | the instructional approach? |
| Analysis - Scope | Additional Information (In Scope/Out of Scope) |
| BusinessImpact - Business | Color-Coded Representation of a Business Readiness Roadmap |
| Readiness | (as completed by the LC) |
| Analysis - Business Readiness | Color-Coded Representation of a Business Readiness Roadmap |
| | (as completed by the ID) |
| | Project Readiness Recommendation (as recommended by the |
| | ID) |
| Analysis - Risk Dependencies | Risk/Dependencies Description |
| | Consequences |
| | Mitigation Plan |
| | Risk Type |
| Analysis - Curricula | Date the Solution is Required to Begin Review Cycle |
| Integration/Maintenance | Frequency of Review |
| | Expected Time Commitment for each Review Completion |
| | Curriculum Owners |
| Analysis - SMEs Approvers | Subject Matter Experts (SMEs) and Final Approver |
| | [includes: SMEs, Lead SME, Area of Expertise, Contact |
| | Information (Email), Authorized By, and Contacted and |
| | Advised on Participation] |
| | Final Approver |
| | [includes: Approvers, Final Approver, Title, Contact |
| | Information (Email), Authorized By, Contacted and Advised on |
| | Participation] |
| | Contacts |
| | [includes name and e-mail of: LOB Project Sponsor, Policy and |
| | Procedure Contacts, Learning Manager, Learning Consultant, |
| | Measurement Consultant, Other, Legal Reviewer, Compliance |
| | Reviewer and Curricula Management & Integration Learning |
| | Consultant] |
| | Key LOB Stakeholders |
| | [includes: name and e-mail of designated Key LOB |
| | Stakeholders] |
| Analysis - Dates | Target Solution Date from BI Agreement |
| | Training Start Date |
| | Date Required for Pilot Implementation |
| | Impact on Target Dates Based on Analysis |

The Analysis Agreement may also include an Analysis Agreement Sign Off Field. In some embodiments, the third party may be required to review the Analysis Agreement and sign the Sign Off Field prior to providing the business with a learning solution. Upon signing the Analysis Agreement, the terms and conditions in the Analysis Agreement may form the permanent agreement between the business and the third party.

It should be noted that the electronic display included in the Analysis Agreement Tab may be substantially similar to that of a formal document. The electronic display may additionally be a non-selectable display with no options to modify information. In some embodiments, the Homepage may include a button that, when selected, hides the Analysis Tabs and displays only the Analysis Agreement.

It should be noted that one or more of the Analysis Tabs may display one or more questions configured to guide conversations between the ID and the third party. These questions may be displayed next to input fields configured to receive text from the ID relating to answers provided by the third party. Questions that the business requires the ID to ask the third party may be shaded in a first color. Questions that the ID may optionally ask the third party may be shaded in a second color.

A subset of the questions displayed in the Analysis Tabs may be substantially identical to questions displayed in the BI Tabs. In the event that the LC asked a question to the third party that is displayed both in a BI Tab and an Analysis Tab, and the input information relates to an answer received from the third party, the Analysis Tab may display the input information. This may help reduce the possibility of the LC and ID asking the third party the same question multiple times.

The Analysis Tabs may additionally include questions shaded in a third color. These questions may be displayed next to drop-down fields that include selectable answers. These answers may be selected by the ID. The selected answers from these questions may be fed into the LSDM.

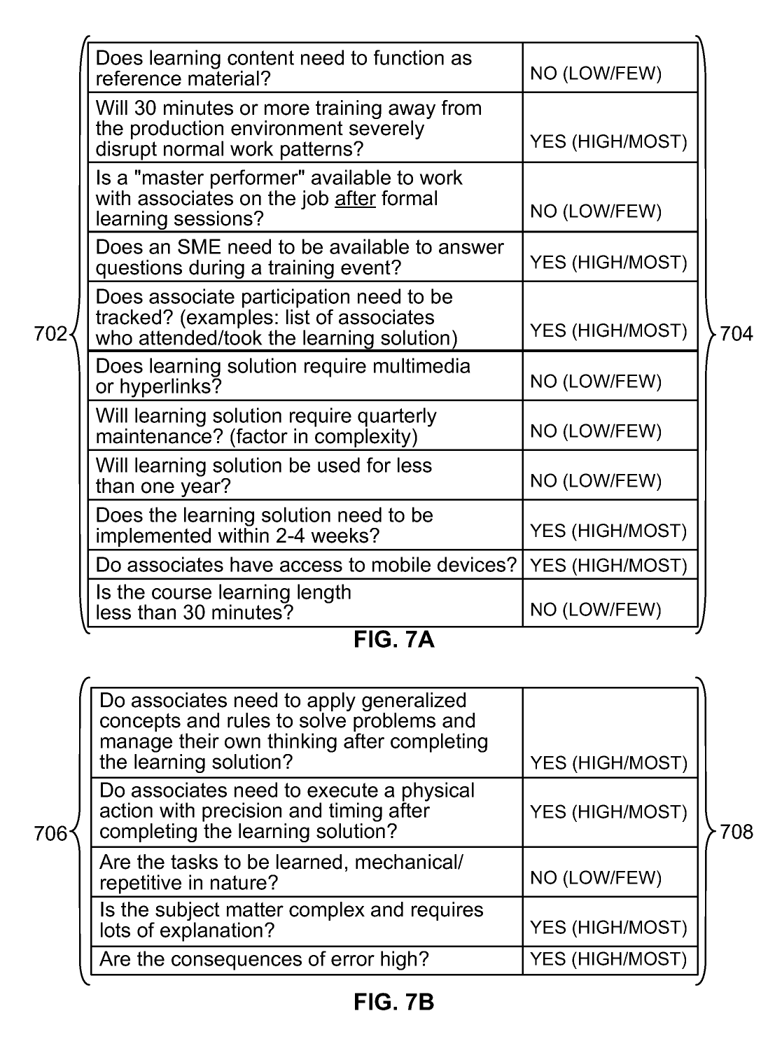

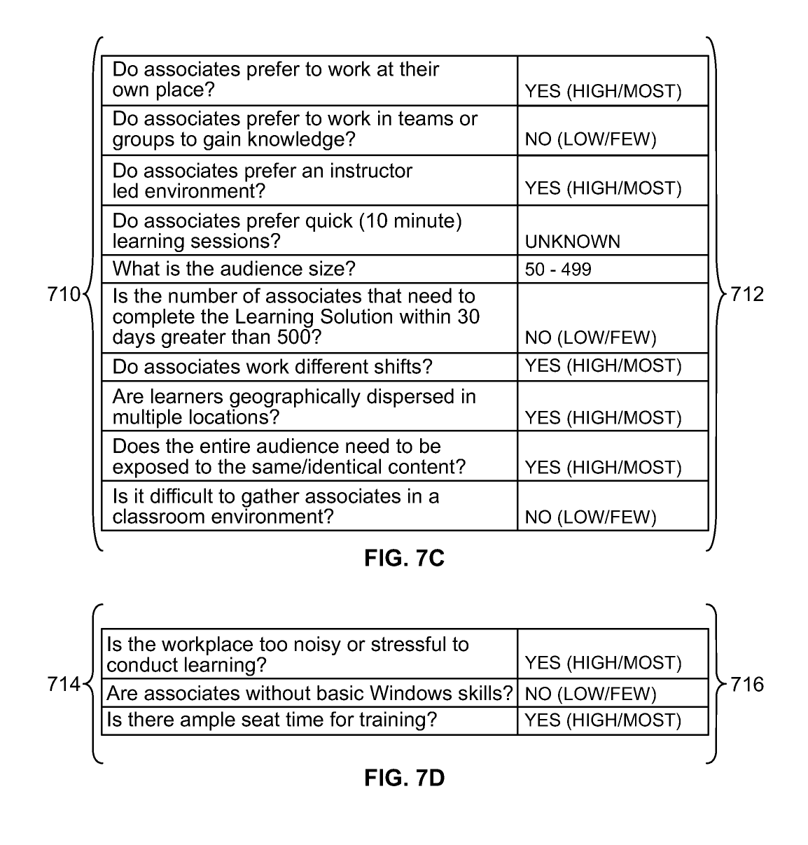

The information fed into the LSDM may include information that describes key characteristics of the group of business employees to be trained, the nature of the information required to be taught to the group of business employees and/or any other suitable information. Exemplary questions and answers that may be included in the Analysis Tabs are illustrated in FIGS. 7A-7D below, and described in the portions of the specification corresponding thereto. The LSDM may use the imported information to generate recommendations as to the appropriateness of a variety of learning solutions.

The LSDM may be incorporated into two or more Analysis Tabs. For example, a first Analysis tab may include the LSDM. The LSDM included in the first Analysis Tab may display input fields automatically populated from information input into the Analysis Tabs. FIGS. 11-18, and the portion of the description corresponding thereto, illustrate the LSDM and the calculations performed by the LSDM.

A second Analysis Tab may include an LSDM Summary Tab. The LSDM Summary Tab may display a summary of the results computed by the LSDM. For example, the LSDM may display a score for each of a plurality of learning solutions. The score computed for a learning solution may relate to the desirability of using the learning solution to train the group of business employees. The score attributed to each of the learning solutions may be displayed numerically, in the form of a percentage and/or using one or more graphical representations.

It should be noted that, upon completion of the BI Agreement and/or the Analysis Agreement, the PLAT and the LSDM may be uploaded to a folder for archiving purposes.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the PLAT and the LSDM may be embodied as a method, a data processing system, or a computer program product. Accordingly, the PLAT and the LSDM may take the form of an entirely hardware embodiment, an entirely software embodiment or an embodiment combining software and hardware aspects.

Furthermore, the PLAT and the LSDM may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that the PLAT and/or the LSDM is embodied at least partially in hardware, each of the PLAT and/or the LSDM may include one or more databases, receivers, transmitters, processors, modules including hardware and/or any other suitable hardware. Furthermore, the operations executed by the PLAT and the LSDM may be performed by the one or more databases, receivers, transmitters, processors and/or modules including hardware.

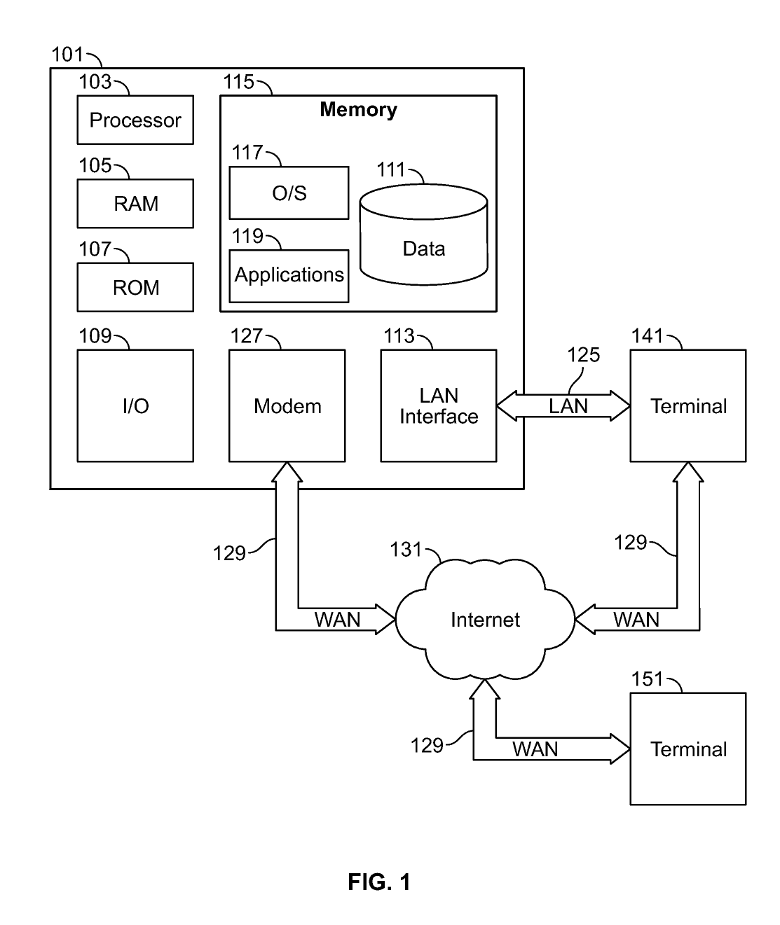

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). As described in detail below, database 111 may provide storage for information input into the PLAT and the LSDM.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by the LC and the ID to access and input information into the PLAT. Information input into the PLAT may be stored in memory 115. The input information may be processed by an application such as one of applications 119.

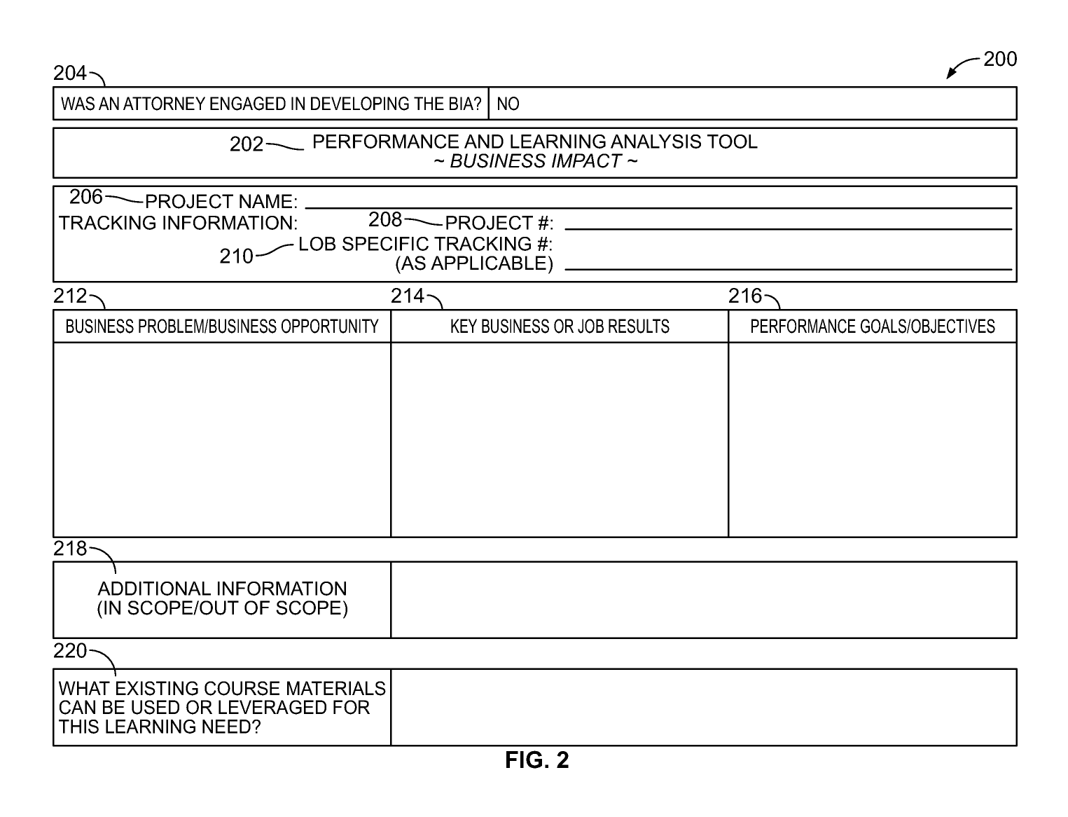

FIG. 2 shows illustrative graphical user interface (“GUI”) 200 that may be used in accordance with the systems and methods of the invention. GUI 200 may be displayed in response to the selection of a BI Tab included in a PLAT in accordance with the systems and methods of the invention.

GUI 200 may include header “Performance and Learning Analysis Tool—Business Impact” 202. GUI 200 may additionally include question 204 “Was an Attorney Engaged in Developing the BIA.” A yes/no answer to question 204 may be selectable from a drop-down box included in the input field adjacent to question 204. In GUI 200, an LC has selected the answer no to question 204. It should be noted that, in the event that a yes answer to question 204 is selected, the words “Privileged and Confidential—Attorney Client Communication—Attorney Work Product—Do Not Distribute” may be displayed at the bottom of GUI 200.

GUI 200 may additionally include input fields 206-220. These input fields may include project name 206, project number 208, Line of Business Specific Tracking number 210, Business Problem/Business Opportunity 212, Key Business or Job Results 214, Performance Goals/Objectives 216, Additional Information (In Scope/Out of Scope) 218, and What Existing Course Materials Can Be Used or Leveraged for This Learning Need 220.

It should be noted that one or more of these input fields may be required input fields. In the event that one or more of these input fields are required input fields, the required input fields may be shaded in a first color to signify to the LC that the business requires him to input information into each of these fields. It should additionally be noted that information input into each of the required input fields may be used to populate one or more fields in a BI Agreement according to the invention.

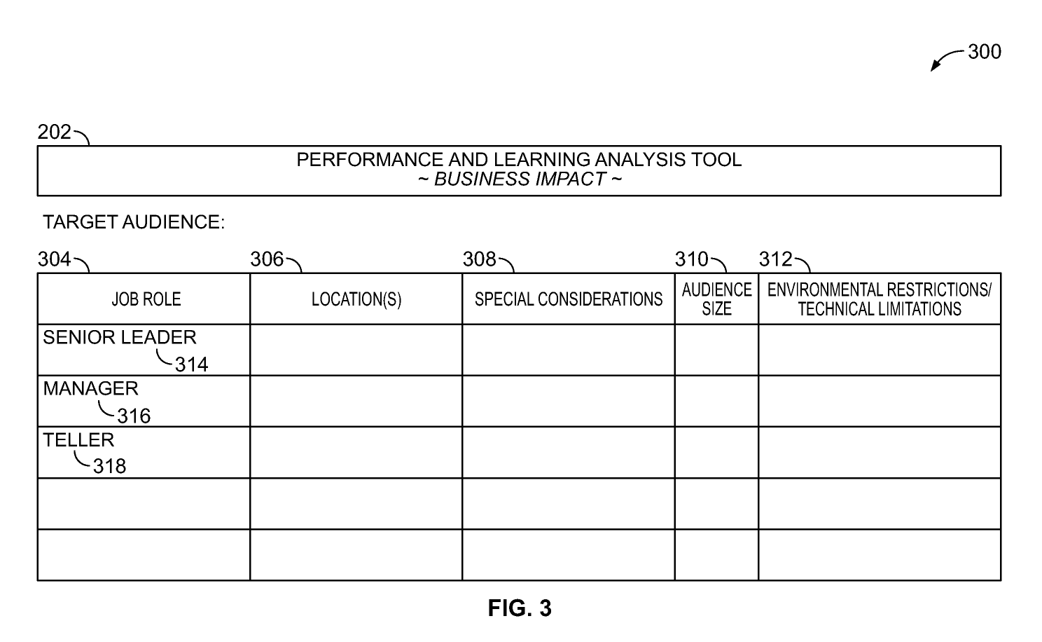

FIG. 3 shows illustrative GUI 300 that may be used in accordance with the systems and methods of the invention. GUI 300 may be displayed in response to the selection of a BI Tab included in a PLAT in accordance with the systems and methods of the invention.

GUI 300 may include header “Performance and Learning Analysis Tool—Business Impact” 202. GUI 300 may also include a chart entitled TARGET AUDIENCE. The chart entitled TARGET AUDIENCE may include column headings Job Role 304, Location(s) 306, Special Considerations 308, Audience Size 310, and Environmental Restrictions/Technical Limitations 312. In GUI 300, the LC has input three Job Roles into the TARGET AUDIENCE chart: Senior Leader 314, Manager 316 and Teller 318. It should be noted that the Job Roles: Senior Leader, Manager and Teller are exemplary. Any Job Roles suitable for the project being considered may be input into a GUI according to the systems and methods of the invention.

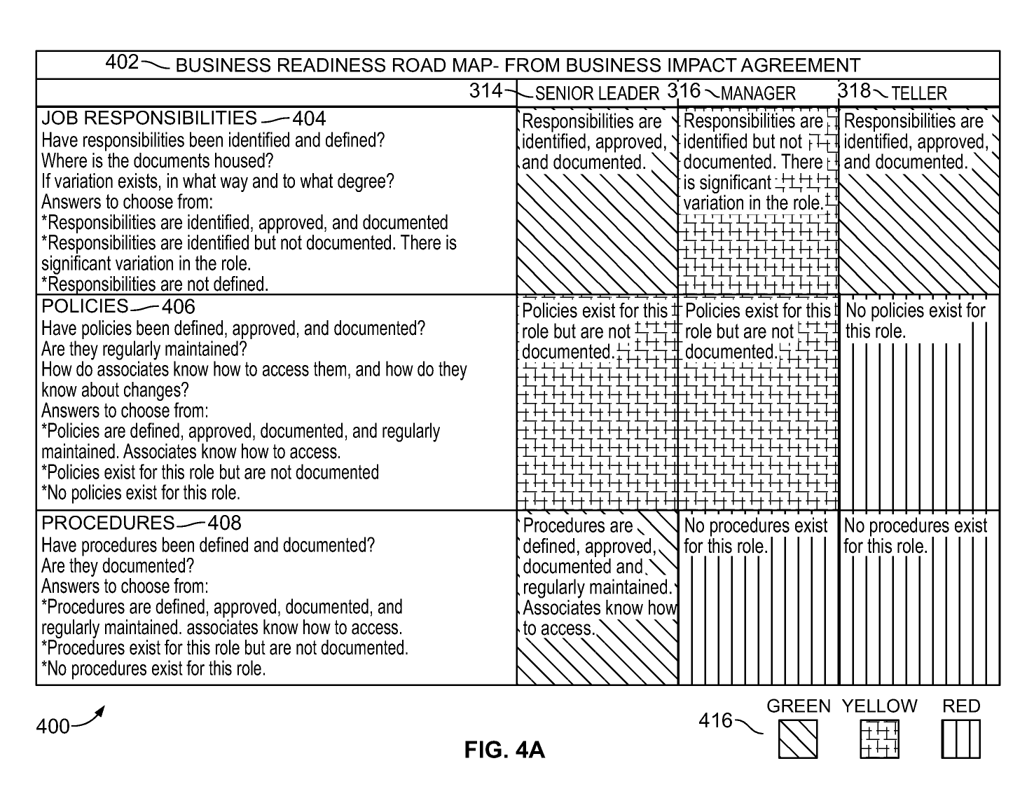

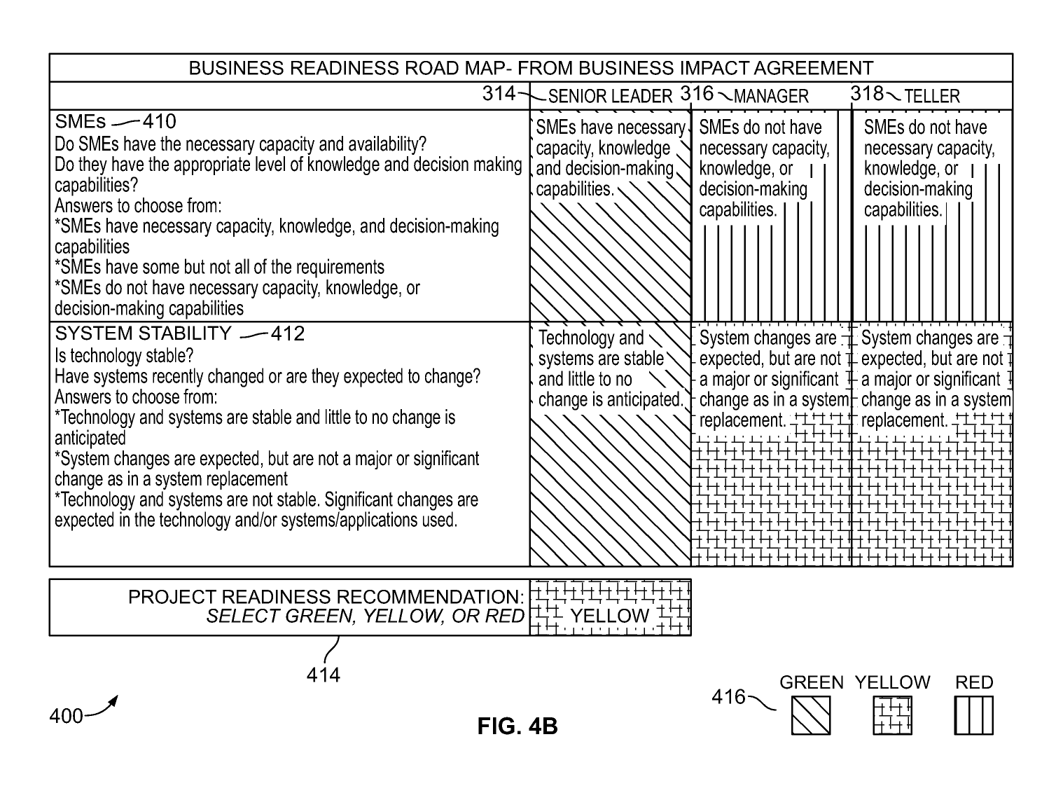

FIGS. 4A-4B show illustrative GUI 400 that may be used in accordance with the systems and methods of the invention. GUI 400 may be displayed in response to the selection of a BI Tab included in a PLAT in accordance with the systems and methods of the invention.

GUI 400 may include header “Business Readiness Road Map—From Business Impact Agreement” 402. GUI 400 may also include column headings Senior Leader 314, Manager 316 and Teller 318. It should be noted that the PLAT may automatically populate column headings 314-318, based upon input information, into the TARGET AUDIENCE chart included in GUI 300.

GUI 400 may also include a column of question cells. The questions included in the column of question cells may relate to Job Responsibilities 404, Policies 406, Procedures 408, SMEs 410 and System Stability 412. GUI 400 may display, in each of the question cells 404-412, a question and answers to choose from. The questions included in question cells 404-412 may be questions that, when answered, assist the LC in determining if the business is ready to contract a the third party to train a group of employees.

Selection of each of the empty cells included in GUI 400 may initiate the display of a drop down box. The drop down box may include selectable answers to the question displayed in the same row as the selected cell. Upon selection of an answer, the GUI may display the selected answer. In some embodiments, upon selection of an answer, the GUI may additionally shade the cell in a predetermined color. The color may represent whether the business is ready to proceed with design and development of the learning solution. The color may be based on the answer selected.

For example, in exemplary GUI 400, in the event that the LC selects an answer to a question that indicates that the business is not ready to design and develop the learning solution, GUI 400 shades the cell in the color red. In the event that the LC selects an answer to a question that indicates that the business is somewhat ready to design and develop the learning solution, GUI 400 shades the cell in the color yellow. In the event that the LC selects an answer to a question that indicates that the business is ready to design and develop the learning solution, GUI 400 shades the cell in the color green. Color Legend 416 identifies the color associated with each of the shadings included in GUI 400.

GUI 400 may additionally include Project Readiness Recommendation 414. Project Readiness Recommendation 414 may enable the LC to select a color to define the readiness of the project designed to design and develop the learning solution.

It should be noted that answers selected in GUI 400 may be fed into other BI/Analysis Tabs included in the PLAT. For example, one or more of FIGS. 6, 8 and 9 may include information fed from GUI 400.

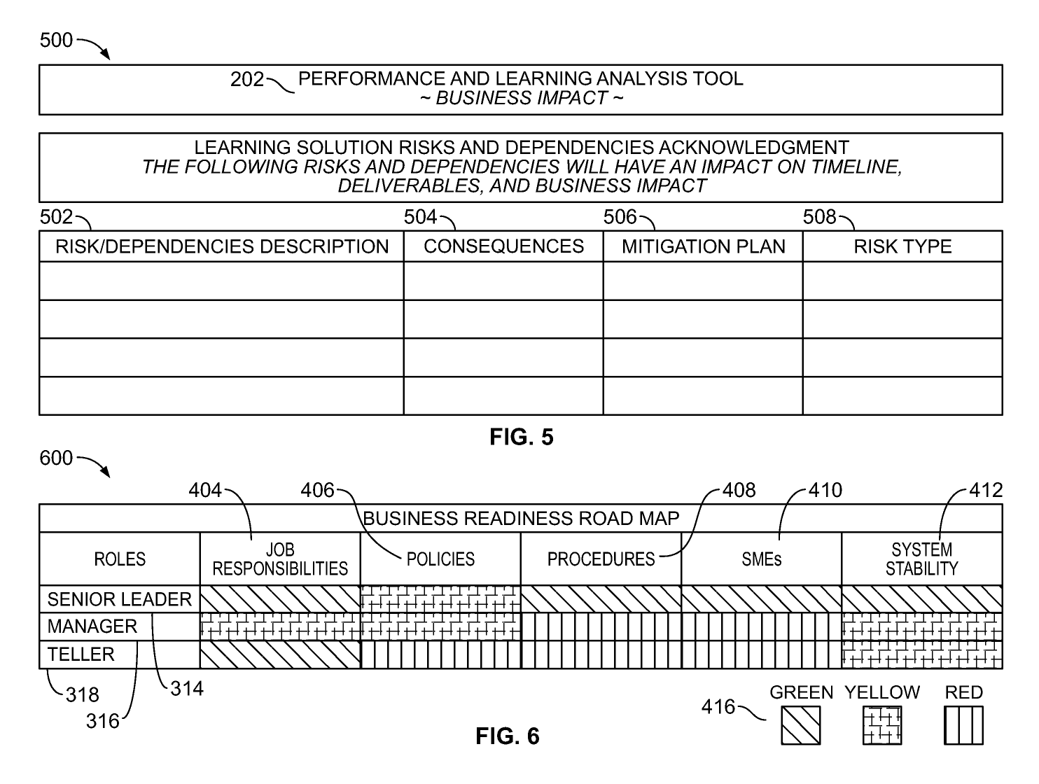

FIG. 5 shows illustrative GUI 500 in accordance with the systems and methods of the invention. GUI 500 may be displayed in response to the selection of a BI Tab included in a PLAT in accordance with the systems and methods of the invention.

GUI 500 may include header “Performance and Learning Analysis Tool—Business Impact” 202. GUI 500 may also include column headings Risk/Dependencies Description 502, Consequences 504, Mitigation Plan 506 and Risk Type 508.

FIG. 6 shows illustrative GUI 600 in accordance with the systems and methods of the invention. GUI 600 may be displayed in response to the selection of a BI Tab included in a PLAT in accordance with the systems and methods of the invention. In some embodiments, GUI 600 may be included in the BI Agreement generated by the PLAT.

GUI 600 may include column headers Job Responsibilities 404, Policies 406, Procedures 408, SMEs 410 and System Stability 412. GUI 600 may also include a column entitled “Roles” that includes Senior Leader 314, Manager 316 and Teller 318. In some embodiments, the Roles column may be automatically populated, with input information, into GUI 300. Additionally, GUI 600 may include multiple shaded cells. The multiple cells may be shaded automatically by the PLAT to match the shading of the corresponding cells in GUI 500. GUI 600 may also additionally include color legend 416 that specifies a color that is represented by each of the three shadings included in GUI 600.

FIGS. 7A-7D show illustrative questions and answers that may be included in one or more Analysis Tabs included in a PLAT in accordance with the systems and methods of the invention. FIG. 7A shows illustrative questions 702 and illustrative selected answers 704. FIG. 7B shows illustrative questions 706 and illustrative selected answers 708. FIG. 7C shows illustrative questions 710 and illustrative selected answers 712. FIG. 7D shows illustrative questions 714 and illustrative selected answers 716. The questions included in FIGS. 7A-7D are exemplary questions that may be posed by an ID in an Analysis Tab and subsequently fed into the LSDM according to the invention.

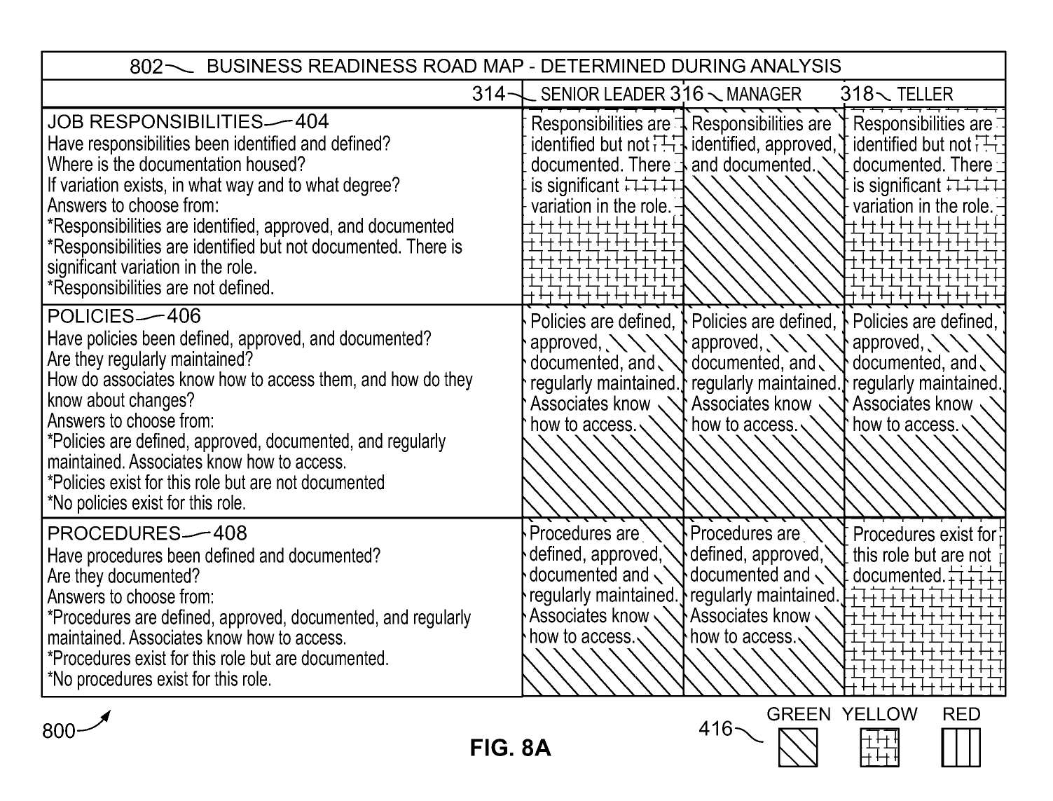

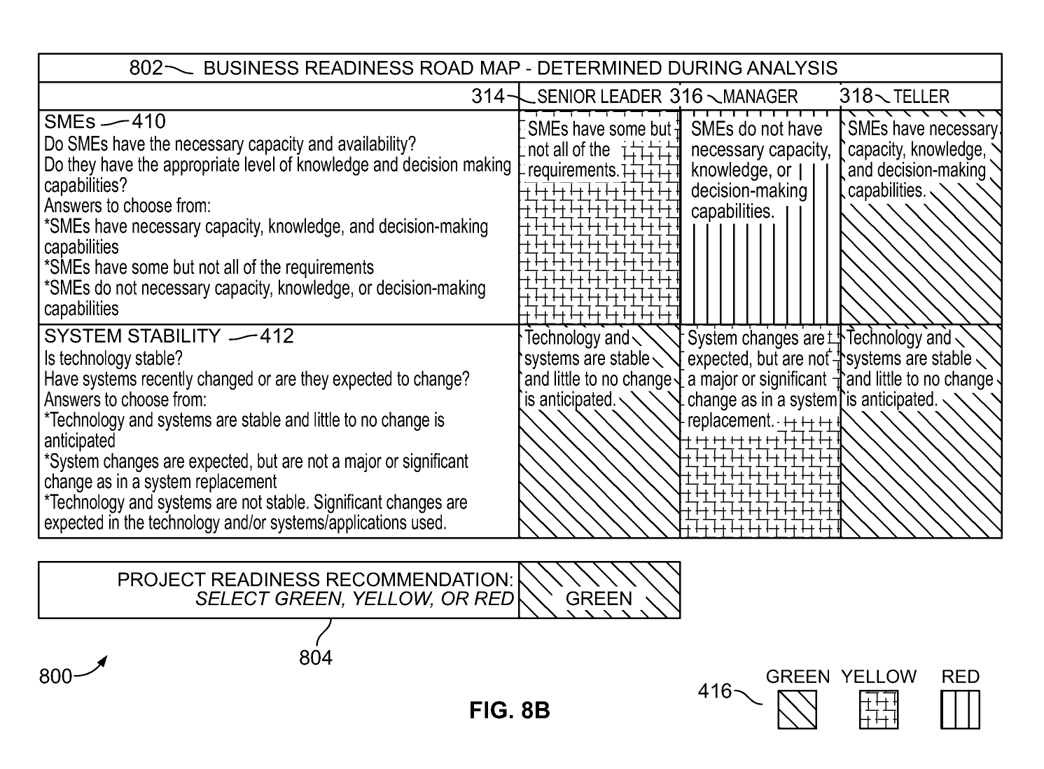

FIGS. 8A-8B show illustrative GUI 800 that may be used in accordance with the systems and methods of the invention. GUI 800 may be displayed in response to the selection of an Analysis Tab included in a PLAT in accordance with the systems and methods of the invention.

GUI 800 may include header “Business Readiness Road Map—Determined During Analysis” 802. GUI 800 may be substantially identical to GUI 400. Specifically, GUI 800 may include column headings Senior Leader 314, Manager 316 and Teller 318. GUI 800 may also include a column of question cells relating to Job Responsibilities 404, Policies 406, Procedures 408, SMEs 410 and System Stability 412. GUI 800 may further include selectable answers to the displayed questions which, when selected, shade the cell in a predetermined color. GUI 800 may also include color legend 416. It should be noted that one or more of the functionalities of GUI 400 may be embodied in GUI 800 as well.

Because GUI 800 is included in an Analysis Tab, the answers to the questions displayed in GUI 800 may be selected by a business ID. GUIs 400 and 800 illustrate that, when an ID answers the displayed questions, the ID may generate a substantially different chart and Project Readiness Recommendation 804 than the chart and the Project Readiness Recommendation 414 generated by the LC.

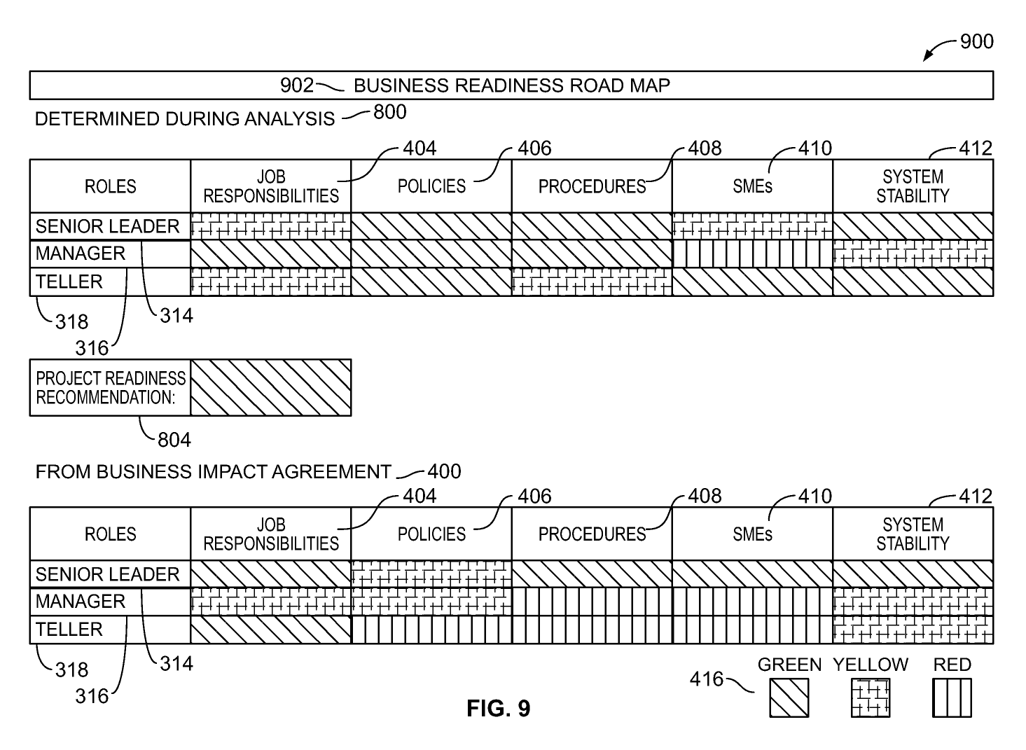

It should be noted that answers selected in GUI 800 may be fed into other Analysis Tabs included in the PLAT. For example, FIG. 9 may include information fed from GUI 800.

FIG. 9 shows illustrative GUI 900 that may be used in accordance with the systems and methods of the invention. GUI 900 may be displayed in response to the selection of an Analysis Agreement generated by a PLAT in accordance with the systems and methods of the invention.

GUI 900 may include header “Business Readiness Road Map” 902. GUI 900 may also include a representation of a Business Readiness Road Map—Determined During Analysis 800. It should be noted that the Business Readiness Road Map—Determined During Analysis 800 may include a visual representation of the columns and rows included GUI 800. In GUI 900, the questions and answers included in GUI 800 have been omitted, and only the shading generated as a result of the answers selected by the ID is displayed. The Project Readiness Recommendation 804 may also be included in GUI 900. It should be noted that the shading of the multiple cells included in Business Readiness Road Map—Determined During Analysis 800 may be shaded automatically by the PLAT to match the shading of the corresponding cells in GUI 800.

GUI 900 may further include a representation of a Business Readiness Road Map—From Business Impact Agreement 400. It should be noted that the Business Readiness Road Map—From Business Impact Agreement 400 may include a visual representation of the columns and rows included in GUI 400. In GUI 900, the questions and answers included in GUI 400 have been omitted, and only the shading generated as a result of the answers selected by the ID is displayed. It should be noted that the shading of the multiple cells included in Business Readiness Road Map—From Business Impact Agreement 400 may be shaded automatically by the PLAT to match the shading of the corresponding cells in GUI 400.

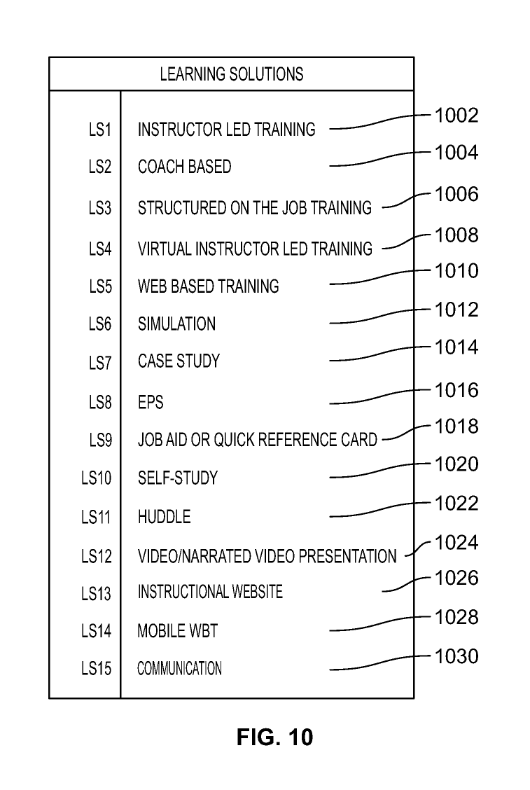

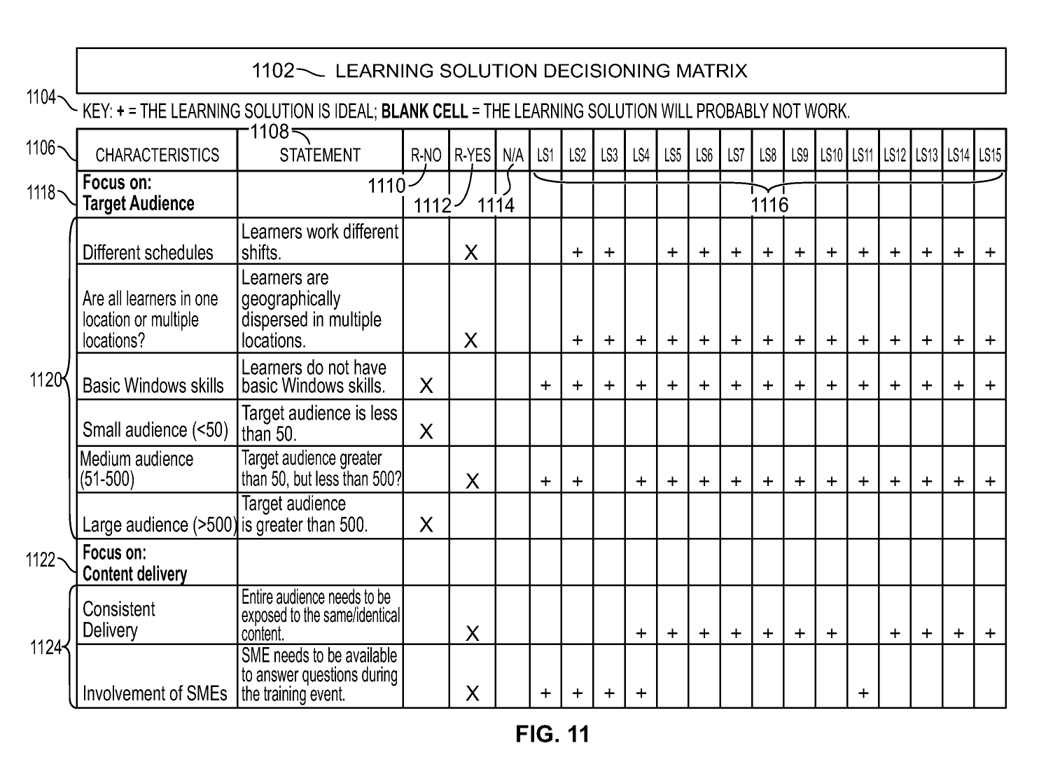

FIG. 10 shows an exemplary chart according to the systems and methods of the invention. FIG. 10 may include a plurality of exemplary learning solutions available to a business. Each of the learning solutions may be used by the business to familiarize a group of employees with one or more new skills, business protocols and/or government regulations.

Exemplary learning solutions included in FIG. 10 are Instructor Led Training 1002, Coach Based 1004, Structured on the Job Training 1006, Virtual Instructor Led Training 1008, Web Based Training 1010, Simulation 1012, Case Study 1014, EPS (Electronic Performance Support) 1016, Job Aid or Quick Reference Card 1018, Self-Study 1020, Huddle 1022, Video/Narrated Video Presentation 1024, Instructional Website 1026, Mobile Web Based Training (“WBT”) 1028 and Communication 1030.

It should be noted that FIG. 10 defines the learning solutions represented by the acronyms LS1-LS15 set forth in FIGS. 11-18, and the portions of the specification corresponding thereto.

It should additionally be noted that the learning solutions included in FIG. 10 are for illustrative purposes only, and represent an exemplary group of learning solutions that a business may consider when contemplating systems and methods for training its employees. Other learning solutions appropriate to train business employees may be included in the systems and methods of the invention.

FIG. 11 shows an exemplary GUI that may be used in accordance with the systems and methods of the invention. The exemplary GUI displayed in FIG. 11 may be displayed in response to the selection of an LSDM Tab in accordance with the systems and methods of the invention.

FIG. 11 may include header “Learning Solution Decisioning Matrix” 1102. FIG. 11 may also include key 1104 that explains the meaning of a portion of the displayed cells. Key 1104 states that, for the cells located in the learning solution (“LS”) columns, a “+” indicates that the learning solution referenced in the column header is ideal. Alternatively, for cells located in the LS columns, a blank cell indicates that the learning solution referenced in the column header will probably not work. It should be noted that the factor that determines whether or not a “+” is displayed in a cell located in row x is the answer received by the PLAT relating to Statement 1108 located in row x.

For example, the second statement included in FIG. 11, included in the column Statement 1108, is “Learners are Geographically dispersed in multiple locations.” The ID's response to this statement was yes, as evidenced by the “x” displayed in the R—Yes column. The LSDM has determined that, based on the ID's selected response to the statement, LS1—Instructor Led Training—is not an ideal learning solution, whereas LS2—Coach Based Training—and LS3—Structured On the Job Training—are better learning solutions. When training multiple employees dispersed in multiple locations, it may not be ideal to train them using an instructor at least because such an approach would require transportation of the instructor to the multiple locations. This is in contrast to coach-based training and on the job training, both of which are cheaper approaches that can be more easily implemented in the multiple locations where the employees are located.

It should be noted that each row included in FIG. 11 may relate to a question answered by the ID in one of the analysis tabs. The questions represented in the rows may relate to questions included in the Analysis Tabs with a selectable answer displayed next to each question. Exemplary questions with selectable answers that may be displayed to the ID and fed into the LSDM are illustrated in FIGS. 7A-7D above. For the purposes of FIGS. 11-18, a question with selectable answers that are are fed into the LSDM, when selected, will be referred to alternately hereinafter as a “Question.”

Column headers relating to the Question may include columns: Characteristics 1106, Statement 1108, R—No 1110, R—Yes 1112, N/A 1114 and Learning Solutions 1116. A cell in column Characteristics 1106 may include text that describes a characteristic being emphasized in a Question. A cell in column Statement 1108 may include a statement relating to the Question asked. In the event that a cell in the R—No 1110 column is checked, this may signify that the ID selected no in response to the Question, and that Statement 1108 is not true. In the event that a cell in column R—Yes 1112 header is checked, this may signify that the ID selected a yes response to the Question, and that Statement 1108 is true. In the event that a cell in column N/A 1114 is checked, this will signify that the ID selected a N/A response to the Question, and that statement 1108 is not applicable to the learning solution that the business is trying to implement.

For example, the first row in FIG. 11 relates to the question “Do associates work different shifts” included in FIG. 7C. This Question has the characteristic “Different schedules,” and the associated statement is “Learners work different shifts.” The ID has selected the response yes from the drop-down list associated with this question, as evidenced from the “X” in the R—Yes column. Based on the answer to this Question, the LSDM has determined that the learning solutions 2-3 and 5-15 are ideal, whereas the learning solution 1 and 4 may not be appropriate.

It should be noted that the exemplary GUI may subdivide characteristics 1106 based on the focus of the characteristics. For example, the characteristics included in FIG. 11 may be divided into (1) Focus on: Target Audience 1118 and (2) Focus on: Content Delivery 1122. Focus on: Target Audience 1118 may include characteristics 1120. Focus on: Content Delivery 1122 may include characteristics 1124.

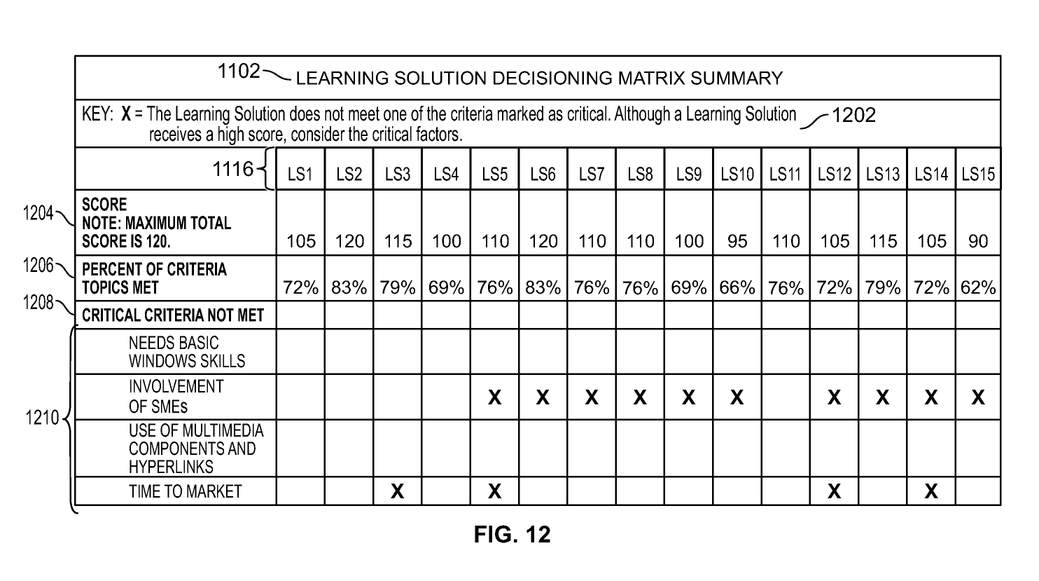

FIG. 11 displays an exemplary portion of the Questions posed to the ID in the Analysis Tabs. In some embodiments, an LSDM may include a representation of each of the Questions imported into the LSDM Tab and used by the LSDM to compute the LSDM Summary Tab (displayed in FIG. 12).

FIG. 12 shows an exemplary GUI that may be used in accordance with the systems and methods of the invention. The exemplary GUI displayed in FIG. 12 may be displayed in response to the selection of an LSDM Summary Tab in accordance with the systems and methods of the invention.

FIG. 12 may include header “Learning Solution Decisioning Matrix” 1102. FIG. 12 may also include key 1202. Key 1202 may state that an X included in an LS column represents that the LS does not meet one of the criteria marked as critical. The Key may additionally state that if a learning solution receives a high score, the ID should consider the critical factors that it fails to satisfy.

FIG. 12 may include Learning Solutions 1116, and score 1204. It should be noted that score 1204 may be computed for each learning solution by (1) adding the numbers of “+”s in the LSDM that are included in the column of a learning solution and (2) multiplying the number of “+”s included in the learning solution's column by 5.

Alternatively, score 1204 may be computed for each learning solution by (1) assigning a value to the learning solution each time a ‘+’ is assigned to the learning solution (i.e., every time a learning solution is determine ideal/desirable based on a response received to a Question), (2) assigning a null value to the learning solution each time a blank cell is assigned to the learning solution (i.e., every time a learning solution is determined undesirable based on a response received to a Question) and (3) summing the values assigned to the learning solution. In FIG. 12, the value assigned to the learning solution each time the learning solution is determined to be desirable is a 5. It should be noted that the invention may include assigning any desirable integer or other suitable value to the learning solution.

FIG. 12 may additionally include Percent of Criteria Topics Met 1206 and Critical Criteria Not Met 1208. It should be noted that the answers to the Questions received by the LSDM may be used by the LSDM to determine which of the critical criteria, for each learning solution, have not been met. The critical criteria 1210 may be determined by a business associate during the creation and/or modification of the PLAT and the LSDM.

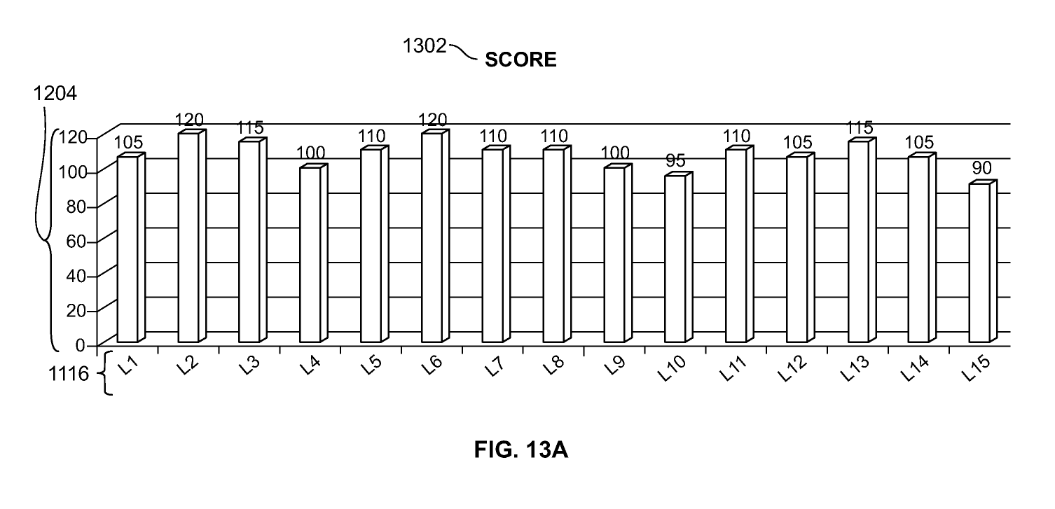

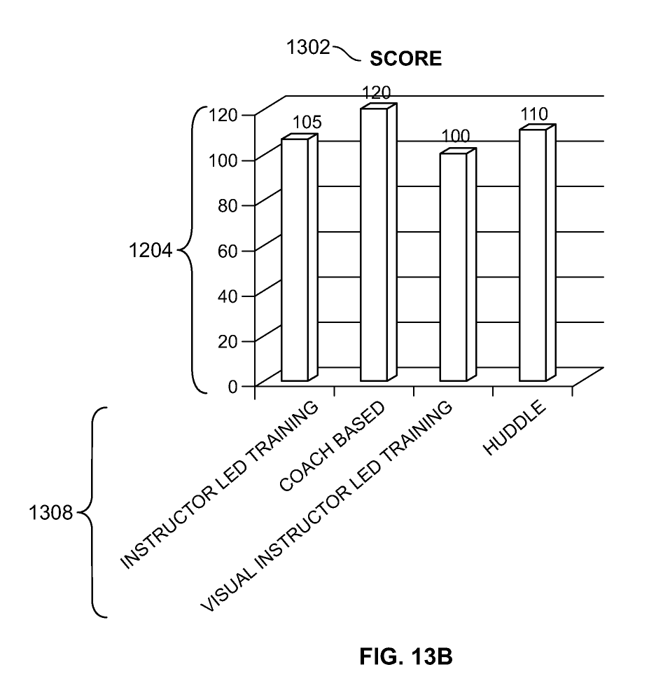

FIG. 13A shows an exemplary graph that may be used in accordance with the systems and methods of the invention. The exemplary graph displayed in FIG. 13A may be displayed in response to the selection of an LSDM Summary Tab in accordance with the systems and methods of the invention. The exemplary graph may include header 1302. The exemplary graph may display a visual representation, using bar graphs, of the scores 1204 calculated by the LSDM for each of the learning solutions 1116.

FIG. 13B shows another exemplary graph that may be used in accordance with the systems and methods of the invention. The exemplary graph displayed in FIG. 13B may be displayed in response to the selection of an LSDM Summary Tab in accordance with the systems and methods of the invention. FIG. 13B may be displayed in the LSDM Summary Tab in addition to, or in place of, FIG. 13A.

The exemplary graph may include header 1302. The exemplary graph may display a visual representation, using bar graphs, of the scores 1204 calculated by the LSDM for each of the learning solutions 1306. The learning solutions 1306 may represent the learning solutions that were determined by the LSDM to meet each of the critical criteria.

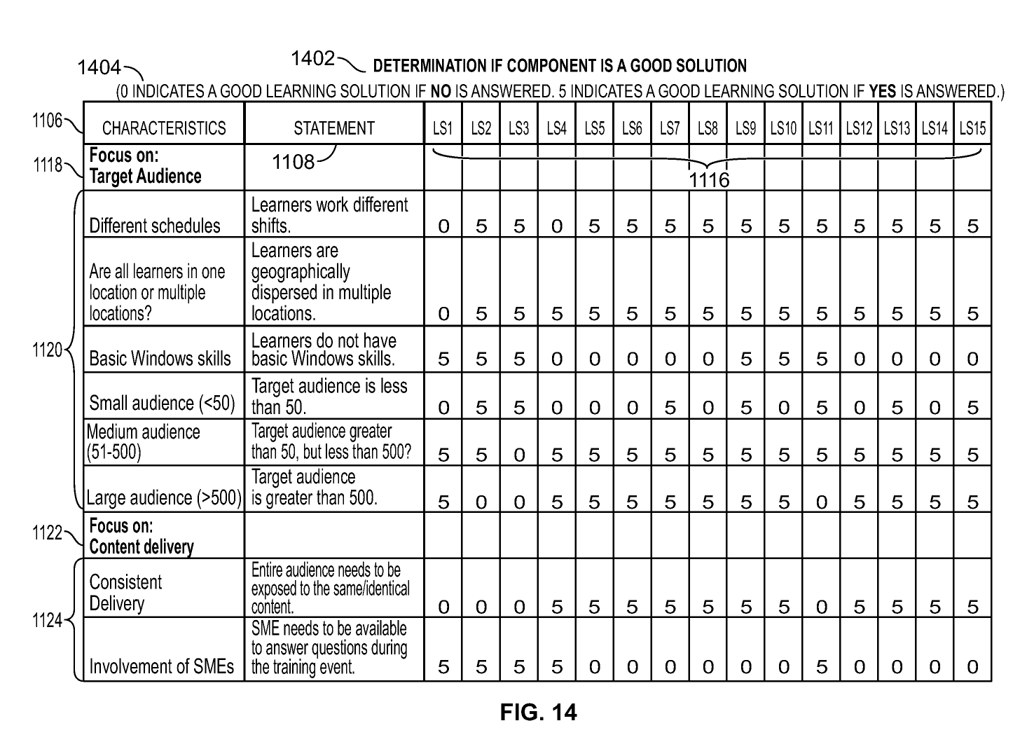

FIG. 14 shows an exemplary GUI that may be used in accordance with the systems and methods of the invention. The exemplary GUI displayed in FIG. 14 may be displayed in response to the selection of an LSDM Tab in accordance with the systems and methods of the invention. The exemplary GUI displayed in FIG. 14 may represent how the LSDM processes the answers to the Questions selected by the ID.

The exemplary GUI displayed in FIG. 14 may include heading “Determination if Component Is a Good Solution” 1402. The exemplary GUI may also include key 1404. Key 1404 may state that a 0, when displayed in a column with an LS header, indicates a good learning solution if NO is answered to a Question referenced in the same row as the 0. Key 1404 also stated that a 5, when displayed in a column with an LS header, indicates a good learning solution if a YES is answered to a Question referenced in the same row as the 5.

It should be noted that FIG. 14 displays the value assigned to each learning solution based on the answer selected by the ID in response to the statement displayed in the statement 1108 column. A ‘5’ may represent a value corresponding to a good learning solution. A ‘0’ may represent a null value corresponding to a poor and/or inefficient learning solution. When the LSDM calculates the score for each learning solution, the LSDM may sum the values included in the learning solution's designated column. For example, when the LSDM calculates the score for LS1, the LSDM may sum all the values in the LS1 column to obtain LS1's score.

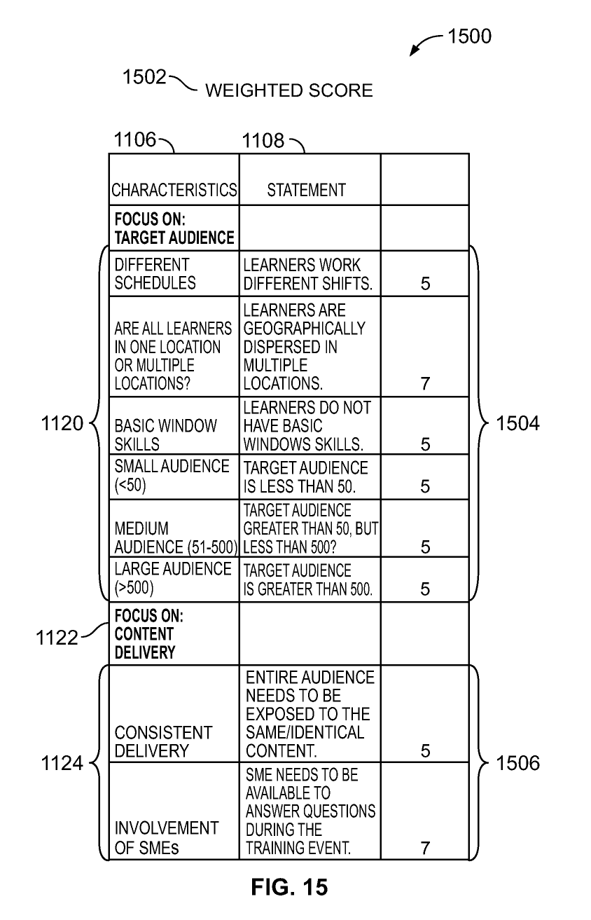

FIG. 15 shows exemplary GUI 1500 that may be used in accordance with the systems and methods of the invention. The exemplary GUI displayed in FIG. 15 may be displayed in response to the selection of an LSDM Tab in accordance with the systems and methods of the invention. The exemplary GUI displayed in FIG. 15 may represent how the LSDM calculates weighted scores for the learning solutions, based on the answers to the Questions selected by the ID.

Exemplary GUI 1500 may include header 1502 entitled “Weighted Score.” GUI 1500 may also include weighted scores 1504 and 1506. Weighted scores 1504 and 1506 may represent a value given to an LS, when the LSDM determines that the LS is a desirable learning solution based on a response to a specific statement included in column Statement 1108.

For example, if an answer selected by an ID in response to a Question relating to statement 1108 ‘Learners Work Different Shifts’ determines that an LS is desirable, the LSDM may assign the value 5 to the LS. If, instead, an answer selected by the ID in response to a Question relating to statement 1108 ‘Learners are Geographically Dispersed in Multiple Locations’ determines that an LS is desirable, the LSDM may assign to a value 7 to the LS.

It should be noted that the values 1504 and 1506 assigned to desirable LSs may be based at least in part on the Questions related to the statements in Statement 1108. For example, a Question, referenced in Statement 1108, with a high relevance to the LS may be assigned a large integer, whereas a Question with a lesser relevance to the LS may be assigned a smaller integer. In GUI 1500, the statement ‘Learners Work Different Shifts’ has been assigned a value 5, whereas the statement ‘Learners are Geographically Dispersed in Multiple Locations’ has been assigned a value 7. The geographic location of the employees to be trained may thus be a more important variable in determining an appropriate learning solution than the shifts that the employees work in the business.

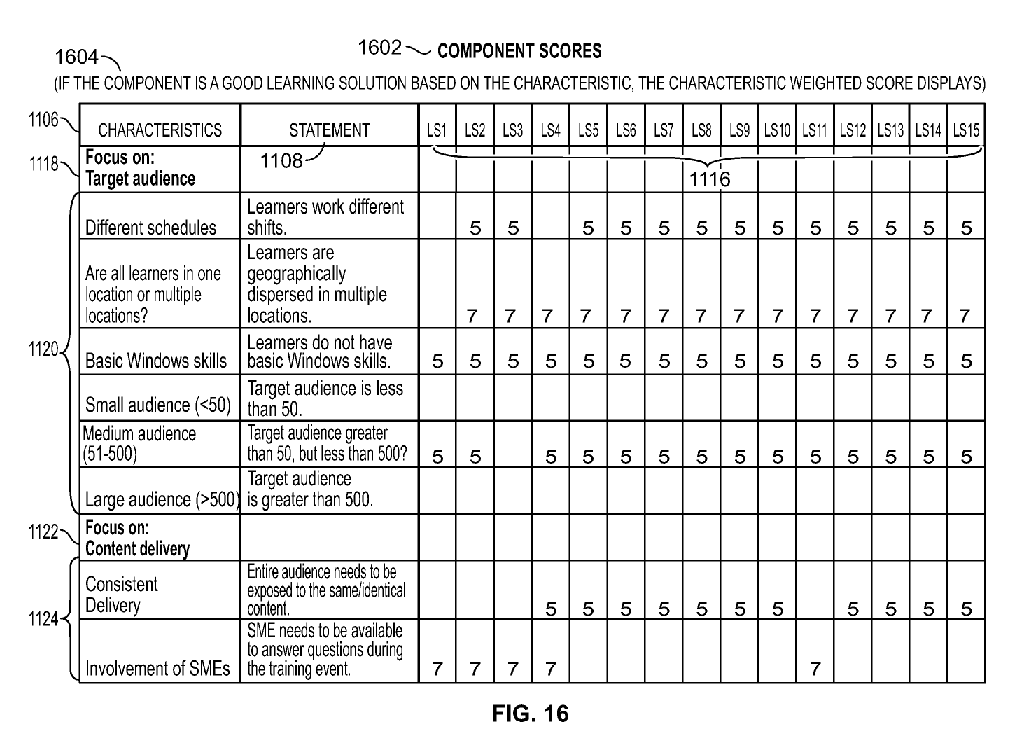

FIG. 16 shows exemplary GUI 1600 that may be used in accordance with the systems and methods of the invention. The exemplary GUI displayed in FIG. 16 may be displayed in response to the selection of an LSDM Tab in accordance with the systems and methods of the invention.

The GUI included in FIG. 16 includes header 1602 entitled “Component Scores” and Key 1604. Key 1604 may state that, in the event that an answer to a Question indicates that a learning solution (or “component”) is desirable, the weight given to the desirable component is displayed in the chart.

It should be noted that GUI 1600 includes a representation of values assigned to LSs determined to be desirable based on answers selected by the ID to a plurality of Questions. The answers selected by the ID to the plurality of Questions, in addition to the LSs determined to be desirable, are displayed in FIG. 11. The values assigned to the desirable LSs are displayed in FIG. 15.

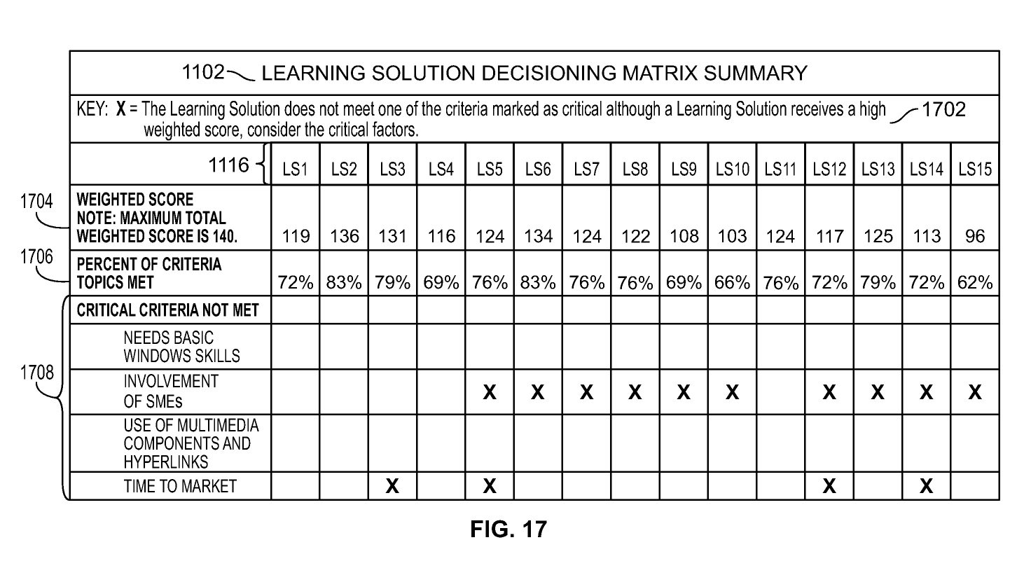

FIG. 17 shows an exemplary GUI that may be used in accordance with the systems and methods of the invention. The exemplary GUI displayed in FIG. 17 may be displayed in response to the selection of an LSDM Summary Tab in accordance with the systems and methods of the invention.

FIG. 17 may include header 1102 entitled “Learning Solution Decisioning Matrix Summary.” FIG. 17 may also include key 1702. Key 1702 may state that an “X” included in a column with an LS header represents that the LS does not meet one of the criteria marked as critical. The Key may additionally state that if a learning solution receives a high score, the ID should consider the critical factors that it fails to satisfy.

FIG. 17 may include Learning Solutions 1116, and Weighted Score 1704. It should be noted that Weighted Score 1704 may be computed for each LS by (1) replacing each of the “+”s in FIG. 11 by their weighted values as determined in FIG. 15 and (2) adding the value of the numbers included in the LS's column.

Alternatively, score 1704 may be computed for each learning solution by (1) assigning a value to the learning solution each time a ‘+’ is assigned to the learning solution (i.e., every time a learning solution is determine ideal/desirable based on a response received to a Question), where the value is determined based on the relevance of the Question to the learning solution, (2) assigning a null value to the learning solution each time a blank cell is assigned to the learning solution (i.e., every time a learning solution is determined undesirable based on a response received to a Question) and (3) summing the values assigned to the learning solution. In FIG. 17, the values assigned to the learning solution each time the learning solution is determined to be desirable is a 5 or a 7 (as evidenced in FIG. 16). It should be noted that the invention may include assigning any desirable integer(s) or other suitable value(s) to learning solution determined to be ideal/desirable.

FIG. 17 may additionally include Percent of Criteria Topics Met 1706 and Critical Criteria Not Met 1708. It should be noted that the answers to the questions displayed in FIGS. 7A-7D be used by the LSDM to determine which of the critical criteria, for each learning solution, has been met. The criteria labeled critical by Critical Criteria Not Met 1708 may be determined by a business associate during the creation and/or modification of the PLAT and the LSDM.

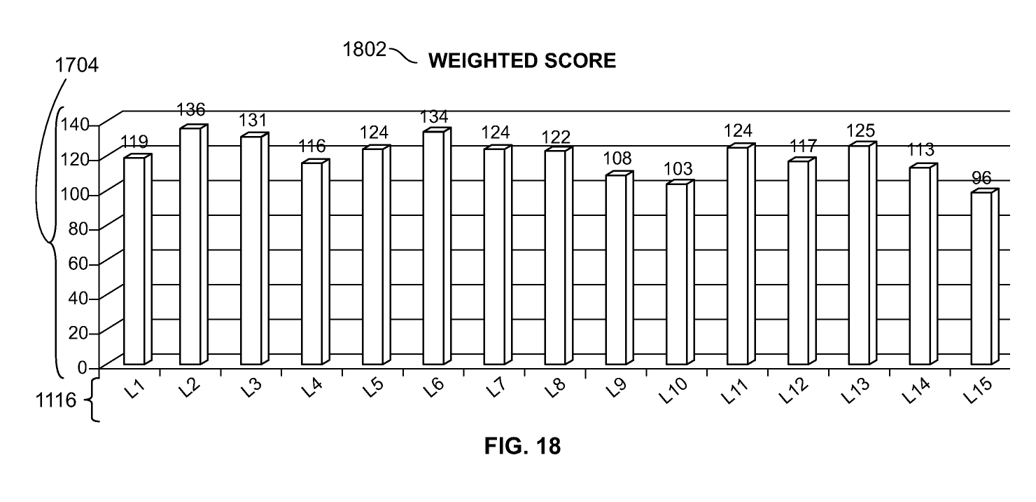

FIG. 18 shows an exemplary graph that may be used in accordance with the systems and methods of the invention. The exemplary graph displayed in FIG. 18 may be displayed in response to the selection of an LSDM Summary Tab in accordance with the systems and methods of the invention. The exemplary graph may include header 1802. The exemplary graph may display a visual representation, using bar graphs or other suitable visual indicator(s), of the weighted scores 1704 calculated by the LSDM for each of the learning solutions 1116.

Thus, methods and apparatus for recommending learning solutions appropriate to train a group of business employees in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for calculating a value relating to the desirability of using a teaching method to train a group of employees, the apparatus comprising:
a receiver configured to receive information relating to a first response selected from a first group of predetermined responses, the first group of predetermined responses relating to responses to a first question;
a processor configured to determine, based on the received first response, (1) if the teaching method is a desirable teaching method, (2) in the event that the teaching method is determined to be a desirable teaching method, assign a first value to the teaching method, wherein the first value is determined based on the relevance of the first question to the teaching method, and (3) in the event that the teaching method is determined to be an undesirable teaching method, assigning a null value to the teaching method;
the receiver being further configured to receive information relating to a second response selected from a second group of predetermined responses, the second group of predetermined responses relating to responses to a second question;
the processor being further configured to determine, based on the received second response, (1) if the teaching method is a desirable teaching method, (2) in the event that the teaching method is determined to be a desirable teaching method, assign a second value to the teaching method, wherein the second value is determined based on the relevance of the second question to the teaching method and (3) in the event that the teaching method is determined to be an undesirable teaching method, assigning a null value to the teaching method; and
the processor being further configured to sum the values assigned to the teaching method and display the sum of the values on a graphical user interface.

2. The apparatus of claim 1, wherein the first value is a first integer and the second value is second integer, different from the first value.

3. The apparatus of claim 1, wherein the teaching method is an instructor-lead training method.

4. The apparatus of claim 1, wherein the teaching method is a mobile web-based training method.

5. The apparatus of claim 1, wherein the first response relates to whether or not the employees are located in the same geographical location and the second response relates to whether or not the employees work the same shifts.

6. The apparatus of claim 1 further comprising a plurality of teaching methods, wherein the processor is configured to determine a value for each of the teaching methods based on the received first response and the second response.

7. The apparatus of claim 6, wherein the values determined for each of the plurality of teaching methods are displayed on a bar graph.

8. One or more non-transitory computer-readable media storing computer-executable instructions which, when executed by a processor on a computer system, perform a method for calculating values relating to the desirability of each of a plurality of teaching methods to train a group of employees, the method comprising:
using a receiver to receive information relating to a first response selected from a first group of predetermined responses, the first group of predetermined responses relating to responses to a first question;
using the processor to determine, based on the received first response, (1) if each of the plurality of teaching methods is a desirable teaching method, (2) in the event that a first subset of the plurality of teaching methods is determined to be desirable teaching methods, assigning a first value to each of the teaching methods included in the first subset, and (3) in the event that a second subset of the plurality of teaching methods is determined to be undesirable teaching methods, assigning a null value to each of the teaching methods included in the second subset;
using the receiver to receive information relating to a second response selected from a second group of predetermined responses, the second group of predetermined responses relating to responses to a second question;
using the processor to determine, based on the received second response, (1) if each of the plurality of teaching methods is a desirable teaching method, (2) in the event that a third subset of the plurality of teaching methods is determined to be desirable teaching methods, assigning a third value to each of the teaching methods included in the third subset, and (3) in the event that a fourth subset of the plurality of teaching methods is determined to be undesirable teaching methods, assigning a null value to each of the teaching methods included in the fourth subset; and
the processor being further configured to sum the values assigned to each of the plurality of teaching methods and display on a graphical user interface an index number based at least in part on the sums of the values.

9. The media of claim 8 wherein, in the method, the learning methods included in the first subset are not included in the second subset and the learning methods included in the third subset are not included in the fourth subset.

10. The media of claim 8 wherein, in the method, the first value is a first integer and the second value is a second integer different from the first integer.

11. The media of claim 8 wherein, in the method, the first value is a first integer and the second value is a second integer numerically equal to the first integer.

12. The media of claim 8 wherein, in the method, the first response and the second response are input into an electronic spreadsheet.

13. The media of claim 8 wherein, in the method, the first response is input into a first electronic spreadsheet and the second response is input into a second electronic spreadsheet.

14. The media of claim 8 wherein, in the method, the plurality of teaching methods include case study, structured on the job training, virtual instructor led training, simulation, self-study, instructional website and mobile web based training.

15. The media of claim 8 wherein, in the method, the first response relates to a course learning length and the second response relates to the complexity of the course subject matter.

16. Apparatus for calculating a value relating to the desirability of using a teaching method to train a group of employees, the apparatus comprising:
a receiver configured to receive information relating to a first response selected from a first group of predetermined responses, the first group of predetermined responses relating to responses to a first question;
a processor configured to determine, based on the received first response, (1) if the teaching method is a desirable teaching method, (2) in the event that the teaching method is determined to be a desirable teaching method, assign a value to the teaching method, and (3) in the event that the teaching method is determined to be an undesirable teaching method, assigning a null value to the teaching method;
the receiver being further configured to receive information relating to a second response selected from a second group of predetermined responses, the second group of predetermined responses relating to responses to a second question;
the processor being further configured to determine, based on the received second response, (1) if the teaching method is a desirable teaching method, (2) in the event that the teaching method is determined to be a desirable teaching method, assign the value to the teaching method and (3) in the event that the teaching method is determined to be an undesirable teaching method, assigning a null value to the teaching method; and
the processor being further configured to sum the values assigned to the teaching method and display the sum of the values on a graphical user interface.
